(19) United States
(12) Patent Application Publication
(10) Pub. No.: US 2016/0092824 A1
(43) Pub. Date: Mar. 31, 2016

(54) SYSTEM AND METHOD FOR CASE MANAGEMENT INFORMATION ENTRY

(71) Applicants: Michael Lynn Edwards, JR., San Bernadino, CA (US); Leilani Tirona Edwards, San Bernadino, CA (US)

(72) Inventors: Michael Lynn Edwards, JR., San Bernadino, CA (US); Leilani Tirona Edwards, San Bernadino, CA (US)

(21) Appl. No.: 14/865,723

(22) Filed: Sep. 25, 2015

Related U.S. Application Data
(60) Provisional application No. 62/056,457, filed on Sep. 26, 2014.

(51) Int. Cl. G06Q 10/06; G06Q 50/26; G06F 17/30

(52) U.S. Cl. CPC G06Q 10/063114; G06F 17/30126; G06Q 50/26

(57) ABSTRACT

A system and method for case management information entry provides a user interface for entry of case management events. Some embodiments provide a display showing events and determine deadlines or due dates for follow-up events/actions based on rules associated with an event entry. Other embodiments provide a quick populate feature that enters user defined pre-set entries for an associated case type. Other embodiments provide a translation feature for short hand entries that spells out the full length word or term for a short hand entry.

### CROSS-REFERENCE TO RELATED APPLICATIONS

This application claims benefit under 35 U.S.C. §119(e) of U.S. Provisional Application having Ser. No. 62/056457 filed Sep. 26, 2014, which is hereby incorporated by reference herein in its entirety.

### BACKGROUND

The embodiments herein relate generally to systems and methods providing entry of case management information.

Current case management tools and systems rely on manual entry and tracking of events and follow-up actions. A case management worker must manually calculate due dates and docket into their own generated docketing system important notes and due dates. Such docketing systems, if used, are generally distinct from the paperwork manually filled out to record activity for a given client file. This has led to common occurrences of case management activity not being performed on time or outright forgotten. The time required to fill out paperwork alone contributes to overloading the worker's availability to work on cases. In addition, some records must be done twice because the worker used shorthand that is understood or acceptable among peers but is unacceptable for official reports. Embodiments disclosed below solve these problems.

### SUMMARY

In one aspect of the subject disclosure, a computer program product for providing a human services case management entry display comprises a non-transitory computer readable storage medium having computer readable program code embodied therewith. The computer readable program code may be configured to: provide through a computing device, an electronic portal for user interaction; display on the electronic portal a human services case management file; determine a plurality of human services event deadlines based on a case type associated with the human services case management file; determine a case management action requirement to satisfy each of the plurality of human services event deadlines; display a first status indicator in response to the case management requirement not being met; receive a user input entry in response to the user performing the case management action; and display a second status indicator in response to the case management action being met.

In another aspect of the subject disclosure, a computer program product for providing a human services case management entry display comprises a non-transitory computer readable storage medium having computer readable program code embodied therewith. The computer readable program code may be configured to: provide through a computing device, an electronic portal for user interaction; display on the electronic portal a human services case management file; determine a plurality of human services event deadlines based on a case type associated with the human services case management file; determine a case management action requirement to satisfy each of the plurality of human services event deadlines; receive a user entry including shorthand terms in response to the user performing the case management action; translate the shorthand terms into words; and display the words from the translated shorthand terms as a record associated with performance of the case management action.

### BRIEF DESCRIPTION OF THE FIGURES

The detailed description of some embodiments of the invention is made below with reference to the accompanying figures, wherein like numerals represent corresponding parts of the figures.

FIG. 1 is a flowchart of a process for managing social services cases according to an embodiment of the subject technology.

FIGS. 2A-2C are screenshots of a software app and user interface according to an embodiment of the subject technology.

FIG. 3 is a flowchart of a process for setting up and using a quick populate feature according to an embodiment of the subject technology.

FIG. 4 is a screenshot of another user interface of the software app of FIG. 2A displaying quick populate options according to an embodiment of the subject technology.

FIG. 5 is a screenshot of another user interface of the software app of FIG. 2A showing a case management entry including a quick populate entry.

FIG. 6 is a flowchart of a process for providing short speak and short type translations into a case management entry according to an embodiment of the subject technology.

FIG. 7 is a screenshot of another user interface of the software app of FIG. 2A showing a list of exemplary commonly used acronyms spelled out for case management entries screenshot according to an embodiment of the subject technology.

FIG. 8 is a block diagram of a computing device according to an embodiment of the subject technology.

FIG. 9 is a block diagram of a network according to an embodiment of the subject technology.

### DETAILED DESCRIPTION OF CERTAIN EMBODIMENTS

In general, embodiments of the disclosed invention provide a system and process for automating case management of human services cases to centralize tracking, scheduling, and updating of case events. One or more of the features solve problems associated with synchronizing the various requirements of human services cases from different machine sources into a centralized system.

Aspects of the disclosed invention are described below with reference to block diagrams of methods, apparatus (systems) and computer program products according to embodiments of the invention. It will be understood that each block of the block diagrams, and combinations of blocks in the flowchart illustrations and/or block diagrams, can be implemented by computer program instructions. These computer program instructions may be provided to the processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

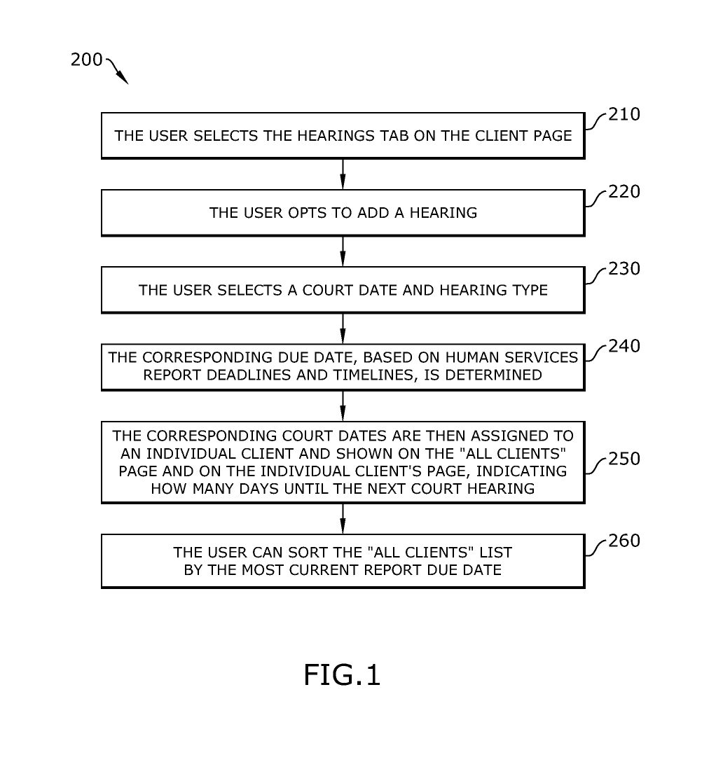

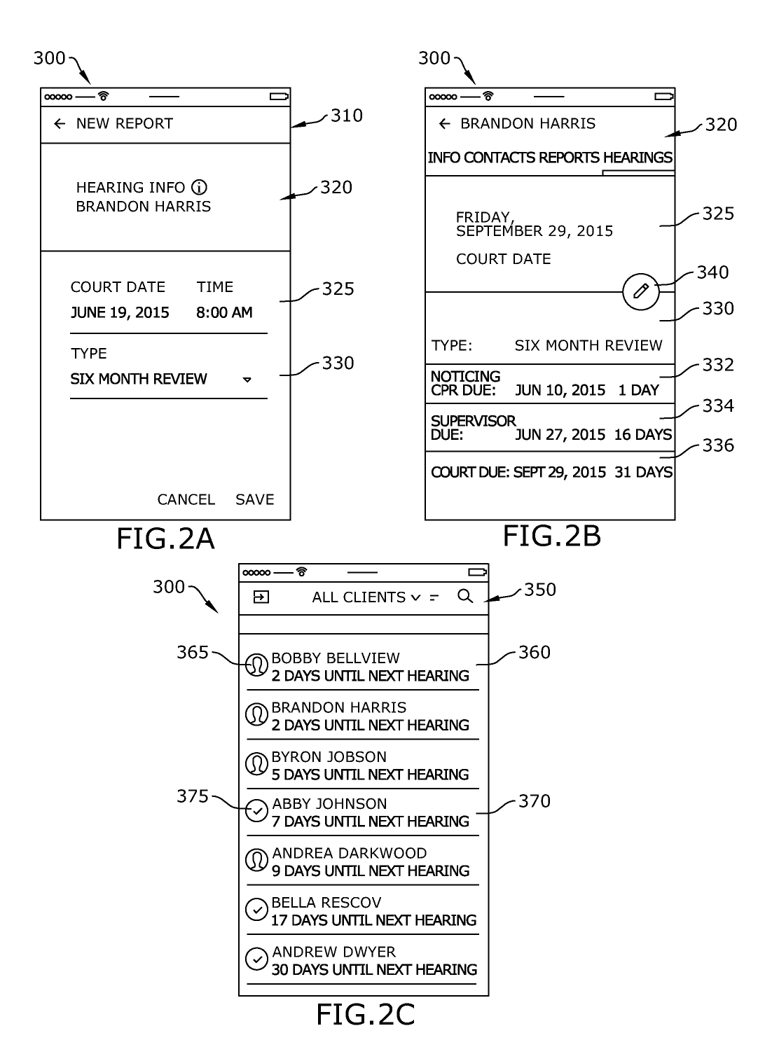

Referring now to FIG. 1, a process 200 for managing human services cases according to an exemplary embodiment of the subject technology is shown. Concurrent reference to FIGS. 2A-2C which show for sake of illustration, some of the steps in the process 200 with exemplary screenshots of user interfaces. It will be understood however that the user interfaces shown may be modified and/or arranged differently than shown. In addition, the steps of process 200 may in some embodiments be independent of the elements in FIGS. 2A-2C. From a user interface 300 accessed via an electronic portal, the user may select (210) a hearings tab 310 on a client file page 320. The user may opt (220) to add information related to a hearing. For example, the user may select (230) a court date 325 and event type 330 to associate with the client file. A processor may determine (240) corresponding due dates or deadlines (332; 334; 336) associated with human services event deadlines based on a case type associated with the human services case management file (for example, meeting dates, status conferences, or the hearing date 325 as shown in FIG. 2A). The due dates or deadlines (332; 334; 336) may be based on timelines associated with human services rules/laws. An edit button 340 allows the user to edit information on the page such as court date, hearing, and time. The processor may assign (250) the determined due dates (332;334;336) to the client file page 320. In some embodiments the due dates may be displayed on a user interface for either a single client file (as shown in FIG. 2B) or on an all clients page 350 displaying dates for all client files (as shown in FIG. 2C). Some embodiments may display the number of days remaining until the next hearing for a client file page 360; 370) or among all clients. The processor may sort (260) and display client file pages in order from the client file page 365 with the closest due date.

In some embodiments, the status of case management events/activity may be conveniently displayed based on actions performed by the user. For example, the user may be required by rule or law to visit a client or submit paperwork within a predetermined time frame based on events in the client's file. The user processor may determine whether the user has recorded an action sufficient to satisfy the requirements by the due date. The all clients page 350 may include a status indicator 365 (for example, a red colored symbol) that represents that a case management action requirement due before the deadline has not been met. This is shown for example with respect to client page file 360. This conveniently reminds the user to check on what requirement has not been met so that it can be performed. Once performed and entered, a status indicator 375 (for example a green colored check mark) may represent that a case management action requirement to be performed before the next deadline has been satisfied, for example as shown with respect to client page file 370.

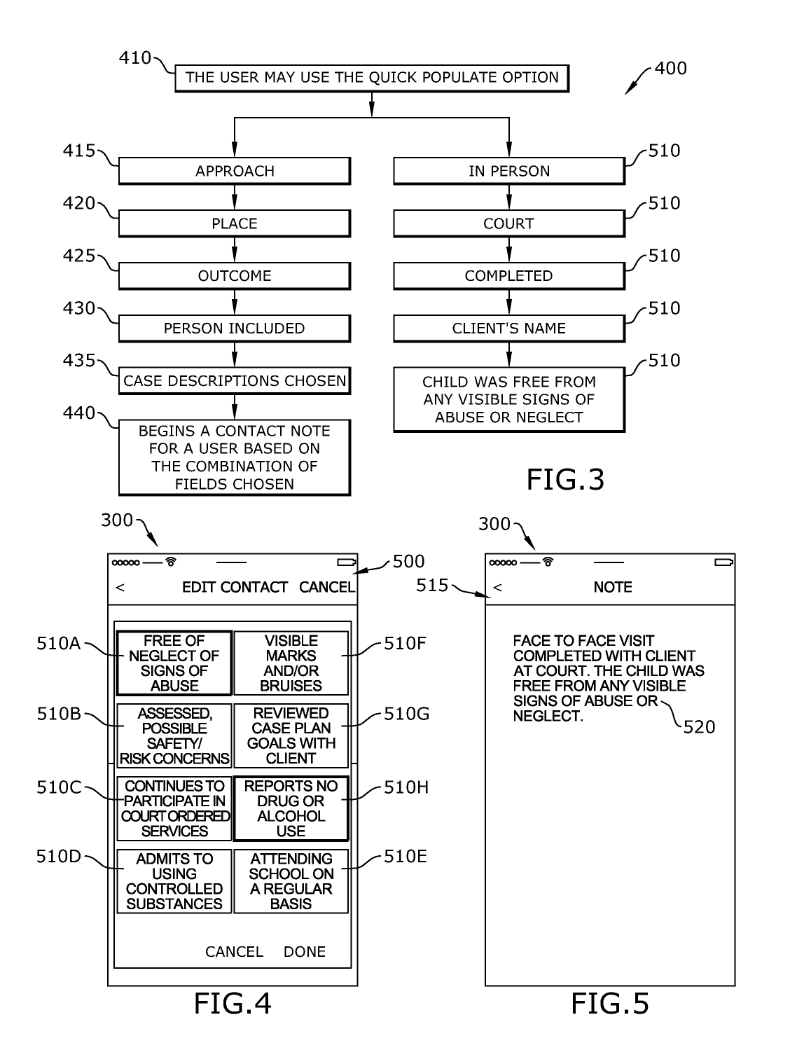

As may be appreciated, a user may spend an inordinate amount of time filling out entries manually under conventional approaches. However, referring now to FIGS. 3-5, a process 400 for quick population of human services entries for a client file is shown according to an exemplary embodiment of the subject technology along with exemplary screenshots of pages 500 and 515 within the user interface 300. Much of the data to be entered in a client's file progression may be repetitive. To provide efficiency in the case management of a client's case, embodiments herein provide a feature to quickly populate information with frequently used data. The process 400 may be invoked by the user triggering (410) the quick populate function. The left side of the process 400 shows the categories that may be associated with the case type. The right side of the process 400 shows examples of pre-set entries (designated generally by numeral 510 as shown in FIG. 4 and referred to generally as pre-set entries 510) defined by the user to quick populate an entry for recordation as an event in a client's file. For example, an approach field 410 may include among the defined pre-set entries 510 for that field as “in person” meaning an in-person visit or meeting. A place field 420 may include for example, “court” representing the location of a meeting. An outcome field 430 may include “completed” as a description of the result of the meeting. A person included field 430 may include an actual client's name of the client being met. A case descriptions chosen field 435 may include pre-set entries of event descriptions that may be expected or common to the case type. For example, as shown in FIG. 4, 510A-510H show examples of event descriptions that the user can define and have ready to select as buttons when recording the details of the case management event. Once the quick populate entries are selected, a contact note 520 describing the event may be generated (440) based on the combination of fields (415-435) chosen for population. An example contact note 520 is shown on an event note page 515 in FIG. 5.

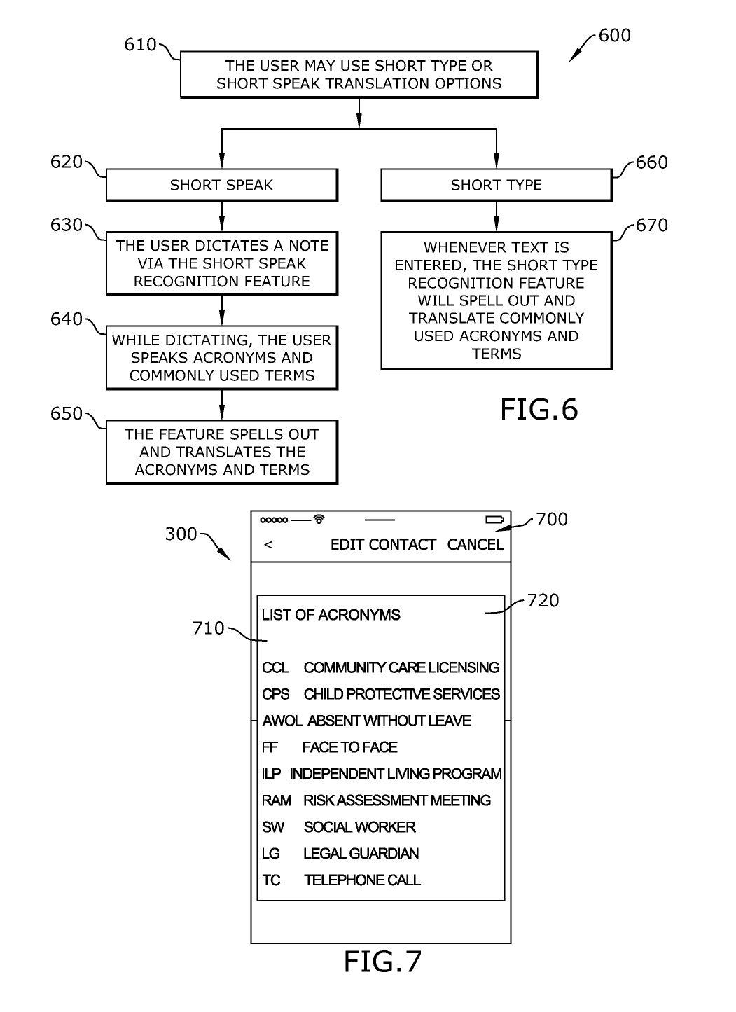

Referring now to FIG. 6, a process 600 for shorthand translation is shown according to an exemplary embodiment with concurrent reference to FIG. 7 showing an example of a common acronyms page 700. As may be known, data entry for many fields may use shorthand to speed the entry process. However, shorthand may not be acceptable for official documentation or understood for those outside of a circle that uses particular jargon. Embodiments herein also provide a feature that automatically translates shorthand entries so that generated reports are clearly understood. As may be appreciated, these embodiments allow the user to continue with the quick entry of information yet shorten the presentation process by automatically spelling out shorthand entries. The left side of process 600 represents dictated entry translation of shorthand (short speak 620) being invoked. The user may dictate (630) a note for use in human services case management via a speech recognition feature of the computing device (described below). The user may speak (640) acronyms and commonly used shorthand terms. The processor may determine and translate (650) the shorthand and acronyms into full length words/terms. The same general process may occur with short hand typing (660) except that typed text is translated (670). In some embodiments, a stored list of acronyms 710 typically associated with the case type may be accessed from the user interface 300. The list of acronyms may include respective spelled out full length words/terms 720. In some embodiments, the list of acronyms 710 and full length words/terms 720 may be user defined.

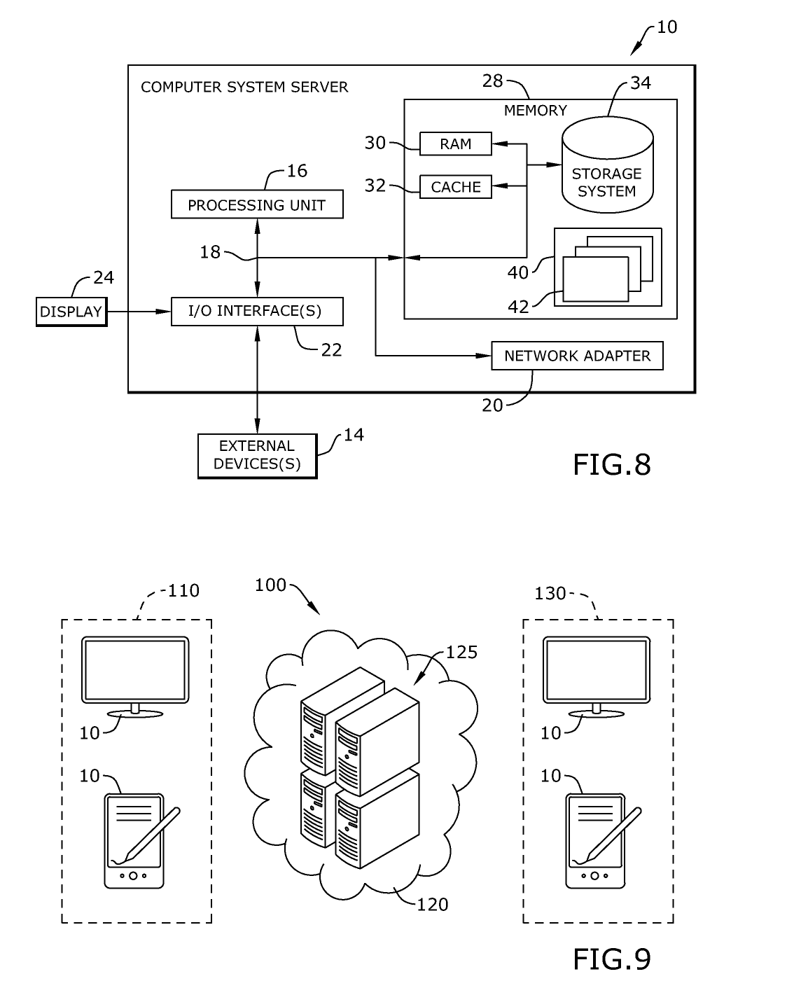

Referring now to FIG. 8, a schematic of an example of a computer computing device 10 is shown. The components of the computing device 10 may include, but are not limited to, one or more processors or processing units 16, a system memory 28, and a bus 18 that couples various system components including the system memory 28 to the processor 16.

The computing device 10 may perform functions as different machine types depending on the role in the system the function is related to. For example, depending on the function being implemented at any given time when interfacing with the system, the computing device 10 may be for example, tablet devices, mobile telephone devices, wearable computing devices, handheld or laptop devices, programmable consumer electronics, or personal computer systems when being used by a case management worker. The computing device 10 may be for example, server computer systems, multiprocessor systems, microprocessor-based systems, network PCs, and distributed cloud computing environments that include any of the above systems or devices, and the like when acting in the role as a host for embodiments of the subject technology or general storage of information for the system. The computer system/server 10 may be described in the general context of computer system executable instructions, such as program modules, being executed by a computer system (described for example, below). In some embodiments, the computing device 10 may be a cloud computing node connected to a cloud computing network (not shown). The computer system/server 10 may be practiced in distributed cloud computing environments where tasks are performed by remote processing devices that are linked through a communications network. In a distributed cloud computing environment, program modules may be located in both local and remote computer system storage media including memory storage devices.

The computing device 10 may typically include a variety of computer system readable media. Such media could be chosen from any available media that is accessible by the computing device 10, including non-transitory, volatile and non-volatile media, removable and non-removable media. The system memory 28 could include one or more computer system readable media in the form of volatile memory, such as a random access memory (RAM) 30 and/or a cache memory 32. By way of example only, a storage system 34 can be provided for reading from and writing to a non-removable, non-volatile magnetic media device typically called a “hard drive” (not shown). The system memory 28 may include at least one program product 40 having a set (e.g., at least one) of program modules 42 that are configured to carry out the functions of embodiments of the invention. The program product/utility 40, having a set (at least one) of program modules 42, may be stored in the system memory 28 by way of example, and not limitation, as well as an operating system, one or more application programs, other program modules, and program data. Each of the operating system, one or more application programs, other program modules, and program data or some combination thereof, may include an implementation of a networking environment. The program modules 42 generally carry out the functions and/or methodologies of embodiments of the invention as described above. Exemplary functions include storing client records, providing a user interface and portal, storing user defined data, receiving user input, quick populating entries, determining dates, and translating shorthand.

The computing device 10 may also communicate with one or more external or integrated devices 14 such as a keyboard, a pointing device, a display 24, etc. In some embodiments, the display 24 may be a touch sensitive screen capable of detecting user input by tactile action. The use of a touch sensitive screen may detect the selection of an element on the display 24, for example, one of the pre-set entries 510 in button form for quick population of a user entry. The devices 14 may also include for example, a network card, modem, etc. that enables the computer system/server 10 to communicate with other computing devices. Such communication can occur via Input/Output (I/O) interfaces 22. Alternatively, the computer system/server 10 can communicate with one or more networks such as a local area network (LAN), a general wide area network (WAN), and/or a public network (e.g., the Internet) via a network adapter 20. As depicted, the network adapter 20 may communicate with the other components of the computer system/server 10 via the bus 18.

As will be appreciated by one skilled in the art, aspects of the disclosed invention may be embodied as a system, method or process, or computer program product. Accordingly, aspects of the disclosed invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the disclosed invention may take the form of a computer program product embodied in one or more computer readable media having computer readable program code embodied thereon.

Any combination of one or more computer readable media (for example, storage system 34) may be utilized. In the context of this disclosure, a computer readable storage medium may be any tangible or non-transitory medium that can contain, or store a program (for example, the program product 40) for use by or in connection with an instruction execution system, apparatus, or device. A computer readable storage medium may be, for example, but not limited to, an electronic, magnetic, optical, electromagnetic, infrared, or semiconductor system, apparatus, or device, or any suitable combination of the foregoing.

Referring now to FIG. 9, a block diagram of a system 100 for communicating case management entry is shown. The system 100 may connect an end user 110 (for example, a case management worker in human services) to a third party 130 (for example, an agency or court) through a network 120. The network 120 may include a server 125 storing and/or hosting a software embodiment of the disclosed invention and in some embodiments, case management records. The end user 110 and third party 130 may interact with the system 100 with an electronic device (for example, a PC or mobile device). It will be understood that the electronic device used by the end user 110 and the third party 130 and the server 125 may function for example, under the description of the computing device 10 of FIG. 8. In some embodiments, the network 120 may be a cloud based environment. In some embodiments, client records related to their physical and behavioral wellness may be stored centralized in the server 125 for access by either the provider or end user client.

Persons of ordinary skill in the art may appreciate that numerous design configurations may be possible to enjoy the functional benefits of the inventive systems. Thus, given the wide variety of configurations and arrangements of embodiments of the present invention the scope of the invention is reflected by the breadth of the claims below rather than narrowed by the embodiments described above.

What is claimed is:

1. A computer program product for providing a human services case management entry display, the computer program product comprising a non-transitory computer readable storage medium having computer readable program code embodied therewith, the computer readable program code being configured to:
provide through a computing device, an electronic portal for user interaction;
display on the electronic portal a human services case management file;
determine a plurality of human services event deadlines based on a case type associated with the human services case management file;
determine a case management action requirement to satisfy each of the plurality of human services event deadlines;
display a first status indicator in response to the case management requirement not being met;
receive a user input entry in response to the user performing the case management action; and
display a second status indicator in response to the case management action being met.

2. The computer program product of claim 1, further comprising computer readable code configured to provide a first user interface, wherein the user defines pre-set entries related to the case type.

3. The computer program product of claim 2, further comprising computer readable program code being configured to provide a second user interface wherein the pre-set entries are selectable as automated entries for the user to select as the user input entry.

4. The computer program product of claim 3, further comprising computer readable program code being configured to change the display of the first status indicator to the second status indicator in response to receiving the selected one of the pre-set entries.

5. The computer program product of claim 4, wherein the computing device is a mobile or wearable device including a touch sensitive screen for receiving the user input entry.

6. The computer program product of claim 5, wherein the pre-set entries are presented as buttons selectable by user touch of the touch sensitive screen.

7. A computer program product for providing a human services case management entry display, the computer program product comprising a non-transitory computer readable storage medium having computer readable program code embodied therewith, the computer readable program code being configured to:
provide through a computing device, an electronic portal for user interaction;
display on the electronic portal a human services case management file;
determine a plurality of human services event deadlines based on a case type associated with the human services case management file;
determine a case management action requirement to satisfy each of the plurality of human services event deadlines;
receive a user entry including shorthand terms in response to the user performing the case management action;
translate the shorthand terms into words; and
display the words from the translated shorthand terms as a record associated with performance of the case management action.

8. The computer program product of claim 7, further comprising computer readable program code being configured to provide a list of selectable acronyms associated with the case type for inclusion in the user entry and display a selected acronym in full word form within the user entry.

9. The computer program product of claim 8, further comprising computer readable program code being configured to:
recognize the user entry from dictated speech, the user entry including an acronym; and
translate the acronym into full word form for display within the record.
